(19) United States
(12) Patent Application Publication
(10) Pub. No.: US 2026/0330247 A1
(43) Pub. Date: Oct. 22, 2026

(54) METHOD FOR ALLOCATING RESOURCES FOR SHOOTING FIRE SUPPORT AND ELECTRONIC DEVICE PERFORMING THE SAME

(71) Applicant: AGENCY FOR DEFENSE DEVELOPMENT, Daejeon (KR)

(72) Inventors: Ye Lim RHIE, Daejeon (KR); Do Hyung KIM, Daejeon (KR); Tae Su CHEONG, Seoul (KR); Jae Won KIM, Seoul (KR); Dong Kyun KIM, Seoul (KR)

(21) Appl. No.: 19/463,751

(22) Filed: Jan. 29, 2026

(30) Foreign Application Priority Data
Mar. 5, 2025 (KR) 10-2025-0028228

(51) Int. Cl. G06N 3/126; F41G 3/00; G06Q 10/0631

(52) U.S. Cl. CPC G06N 3/126; G06Q 10/06315; F41G 3/00

(57) ABSTRACT

Disclosed are systems, devices, methods, and instructions for allocating resources for shooting fire support including generating a chromosome set based on each chromosome containing shooting order information genes for a plurality of targets and shell type information genes used for shooting each of the plurality of targets, acquiring first chromosomes that minimize a threat level of the plurality of targets based on the chromosome set, acquiring a second chromosome that minimizes a time required for shooting each of the plurality of targets based on the first chromosomes, and performing resource allocation based on shooting order information and shell type information identified for the plurality of targets according to the second chromosome.

### PRIORITY INFORMATION

This application claims the benefit of Korean Patent Application No. 10-2025-0028228, filed on Mar. 5, 2025, in the Korean Intellectual Property Office, the disclosure of which is incorporated herein by reference.

### FIELD OF THE INVENTION

The present disclosure relates to systems, devices, methods, and instructions for allocating resources for shooting fire support.

### DESCRIPTION OF THE RELATED ART

In the increasingly diverse modern warfare, it is necessary to recognize rapidly changing battlefield situations and establish resource allocation plans through shooting fire support, comprehensively considering the status of enemy forces, the status of friendly forces, and the resource status for enemy attacks. Shooting fire operations, in particular, are considered a key factor in achieving victory due to their ability to inflict effective damage on enemy forces, necessitating their effective and efficient execution. Enhancing the effectiveness of shooting fire support is achievable through effective decision-making regarding enemy target allocation and shooting sequences based on collected war situation data. Particularly, as the frequency of providing shooting fire support based on unplanned firing missions increases compared to planned firing missions in actual battlefield situations, the importance of flexibly allocating resources for shooting fire support within a short timeframe, considering both the threat level posed by enemy forces and the time required for firing, is growing.

### SUMMARY

Accordingly, the present disclosure is directed to systems, devices, methods, and instructions for allocating resources for shooting fire support that substantially obviates one or more problems due to limitations and disadvantages of the related art.

An aspect provides a method for allocating resources for shooting fire support and an electronic device performing the same, enabling the establishment of an optimized resource allocation method for both cases where there is a resource allocation method for firing at all enemy forces and cases where there is no resource allocation method for firing at all enemy forces in the process of supporting shooting fire, based on the shooting order against the enemy force and the type of shell used for shooting, and facilitating efficient shooting fire support on the battlefield.

The technical aspects of the present disclosure are not limited to those mentioned above, and other technical aspects can be inferred from the following example embodiments.

According to an aspect, there is provided a method for allocating resources for shooting fire support, the method for allocating resources including generating a chromosome set based on each chromosome containing shooting order information genes for a plurality of targets and shell type information genes used for shooting each of the plurality of targets, acquiring first chromosomes that minimize a threat level of the plurality of targets based on the chromosome set, acquiring a second chromosome that minimizes a time required for shooting each of the plurality of targets based on the first chromosomes, and performing resource allocation based on shooting order information and shell type information identified for the plurality of targets according to the second chromosome.

The acquiring of the first chromosomes may include performing a first initialization on chromosomes included in the chromosome set, calculating a first fitness score for chromosomes on which the first initialization has been performed, performing a crossover between chromosomes selected based on the first fitness score, performing a mutation between chromosomes on which the crossover has been performed, and acquiring chromosomes as the first chromosomes, which contain the shooting order information genes and the shell type information genes capable of completing firing at all of the plurality of targets, from among chromosomes having the first fitness score optimized by performing the mutation.

The performing of the crossover may include performing a partially mapped crossover between the shooting order information genes contained in the chromosomes selected based on the first fitness score, and performing a two-point crossover between the shell type information genes contained in the chromosomes selected based on the first fitness score.

The performing of the mutation may include changing an order of the shooting order information genes contained in the chromosomes on which the crossover has been performed, and randomly selecting and determining each of the shell type information genes contained in the chromosomes on which the crossover has been performed from among preset genes.

The first fitness score may be determined based on an initial threat level of the plurality of targets, a residual threat level of the plurality of targets after firing according to the resource allocation, a maximum firing time for the plurality of targets, a firing time according to the resource allocation, and a first parameter concerning a time required for shooting fire support.

The acquiring of the second chromosome may include performing a second initialization on the first chromosomes, calculating a second fitness score for the first chromosomes on which the second initialization has been performed, performing a crossover between the first chromosomes on which the second initialization has been performed, based on the second fitness score, and acquiring one chromosome as the second chromosomes, which has the second fitness score optimized by performing the mutation between the first chromosomes on which the crossover has been performed.

The second fitness score may be determined based on an initial threat level of the plurality of targets, a residual threat level of the plurality of targets after firing according to the resource allocation, a maximum firing time for the plurality of targets, a firing time according to the resource allocation, and a second parameter concerning a time required for shooting fire support.

The shell type information genes contained in the second chromosome may be included in the shell type information genes contained in the first chromosomes.

The method for allocating resources according to an example embodiment may further include, when chromosomes containing the shooting order information genes and the shell type information genes capable of completing firing at all of the plurality of targets do not exist, performing the resource allocation based on the shooting order information and shell type information identified for the plurality of targets according to the chromosome with the maximum first fitness score.

According to another aspect, there is provided a non-transitory computer-readable storage medium having a program for executing a method for allocating resources for shooting fire support on a computer recorded thereon, the method including generating a chromosome set based on each chromosome containing shooting order information genes for a plurality of targets and shell type information genes used for shooting each of the plurality of targets, acquiring first chromosomes that minimize a threat level of the plurality of targets based on the chromosome set, acquiring a second chromosome that minimizes a time required for shooting each of the plurality of targets based on the first chromosomes, and performing resource allocation based on shooting order information and shell type information identified for the plurality of targets according to the second chromosome.

According to yet another aspect, there is provided an electronic device for performing a method for allocating resources for shooting fire support, the electronic device including a memory and a processor, in which the processor is configured to generate a chromosome set based on each chromosome containing shooting order information genes for a plurality of targets and shell type information genes used for shooting each of the plurality of targets, acquire first chromosomes that minimize a threat level of the plurality of targets based on the chromosome set, acquire a second chromosome that minimizes a time required for shooting each of the plurality of targets based on the first chromosomes, and perform resource allocation based on shooting order information and shell type information identified for the plurality of targets according to the second chromosome.

Additional features and advantages of the embodiments will be set forth in the description which follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram illustrating a structure of an electronic device performing a method for allocating resources for shooting fire support according to an example embodiment;

FIG. 2 is a diagram illustrating a method for allocating resources for shooting fire support according to an example embodiment;

FIG. 3 is a diagram illustrating a process of performing resource allocation based on resource sufficiency in a method for allocating resources for shooting fire support according to an example embodiment;

FIG. 4 is a diagram illustrating a process of acquiring first chromosomes in a method for allocating resources for shooting fire support according to an example embodiment;

FIG. 5 is a diagram illustrating a process of acquiring a second chromosome in a method for allocating resources for shooting fire support according to an example embodiment;

FIG. 6 is a diagram illustrating a chromosome containing shooting order information genes and shell type information genes in a method for allocating resources for shooting fire support according to an example embodiment; and

FIG. 7 is an example diagram illustrating an example of performing shooting fire support according to a method for allocating resources for shooting fire support according to an example embodiment.

### DETAILED DESCRIPTION

Hereinafter, various example embodiments of the present disclosure will be described in detail with reference to the accompanying drawings so that those skilled in the art to which the present disclosure pertains can readily practice them. The detailed description set forth below is intended to illustrate example embodiments and is not intended to limit the scope of any particular example embodiment.

The terms used in example embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

The following example embodiments combine components and features of various example embodiments in a predetermined configuration. Each component or feature may be considered optional unless explicitly stated otherwise. Each component or feature may be implemented in isolation without being combined with other components or features. Furthermore, various example embodiments may be formed by combining certain components and features. The order of operations described in the various example embodiments may be changed. Some components or features of one example embodiment may be included in another example embodiment, or replaced by corresponding components or features of another example embodiment.

In the description of the drawings, procedures or steps that could obscure the essence of the various example embodiments have not been described, nor have procedures or steps that would be understood by those skilled in the art at the level of ordinary knowledge been described.

Throughout the specification, when it is stated that a part “comprises” or “includes” a certain component, it means that other components may further be included, and it does not preclude other components, unless otherwise stated. As used herein, the singular form of a noun corresponding to an item may include one or more of those items, unless the relevant context clearly dictates otherwise. As used herein, each of the phrases “A or B,” “at least one of A and B,” “at least one of A or B,” “A, B or C,” “at least one of A, B and C,” and “at least one of A, B or C” may include any of the items listed together in that phrase, or any possible combination thereof. Terms such as “1st”, “2nd”, “first”, or “second” may be used to simply distinguish one such component from another, and do not limit such components in any other aspect (e.g., importance or order).

Each component (e.g., module or program) of the components described herein may include a single or plurality of entities. According to various example embodiments, one or more components or operations of such components may be omitted, or one or more other components or operations may be added. Alternatively or additionally, a plurality of components (e.g., modules or programs) may be integrated into a single component. In such a case, the integrated component may perform one or more functions of each of the components of the plurality of components, the same or similar to those performed by that component of the plurality of components prior to the integration. According to various example embodiments, the operations performed by a module, program, or other component may be executed sequentially, in parallel, or, iteratively, or one or more of the operations may be executed in a different order, omitted, or one or more other operations may be added.

Terms such as “ . . . module”, “ . . . part”, and the like as used herein mean a unit for performing at least one function or operation, which may include a unit implemented as hardware, software, firmware, or as a combination thereof.

Various example embodiments of the present disclosure may be implemented as software (e.g., a program or application) including one or more instructions stored on a storage medium (e.g., memory) readable by a machine. For example, a processor of a machine may call at least one of the one or more instructions stored on the storage medium and execute it. This enables the machine to be operable to perform at least one function in accordance with the at least one instruction called. The at least one instruction may include code generated by a compiler or code that may be executed by an interpreter. The machine-readable storage medium may be provided in the form of a non-transitory storage medium. As used herein, “non-transitory” means only that the storage medium is a tangible device and does not include signals (e.g., electromagnetic waves), and the term does not distinguish between cases where data is stored on the storage medium on a semi-permanent basis and cases where the data is stored on a temporary basis.

Furthermore, specific terms used in various example embodiments are provided to aid in understanding the various example embodiments, and the use of such specific terms may be modified in other forms within the scope that does not depart from the technical concept of the various example embodiments.

A method for allocating resources for shooting fire support and an electronic device therefor proposed in this disclosure aim to establish an optimized firing plan within a short time by considering the status of friendly artillery batteries, the status of enemy targets, and the status of resources such as available ammunition for enemy fire.

In particular, the method for allocating resources for shooting fire support proposed in this disclosure can be effectively applied to the defense sector, where rapid and accurate decision-making is required in battlefield environments. For example, in a battlefield situation, a unit commander needs to execute orders received from a higher-level unit within a short timeframe. Responding to these characteristics of the defense sector, the method for allocating resources for shooting fire support proposed in this disclosure is designed to establish a more realistic resource allocation method for both scenarios where resources for shooting fire support are scarce and where resources are sufficient. It can thus be understood as a technical concept readily applicable to the defense sector.

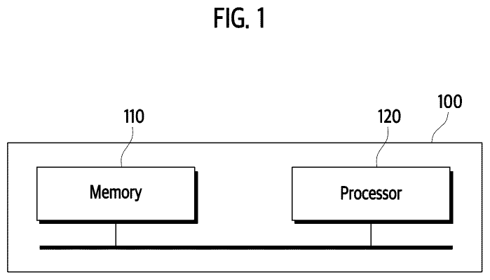

FIG. 1 is a block diagram illustrating a structure of an electronic device performing a method for allocating resources for shooting fire support according to an example embodiment.

Referring to FIG. 1, an electronic device 100 may include a memory 110 and a processor 120 according to an example embodiment. The electronic device 100 shown in FIG. 1 depicts only the components related to this example embodiment, and it will be understood by those skilled in the art related to this example embodiment that other common components may be included in addition to the components illustrated in FIG. 1.

For example, the electronic device 100 may include a communication device (not shown) including one or more transceivers, an input device, and an output device. The communication device is a device for performing wired/wireless communication and may communicate with external electronic devices. The external electronic devices may be terminals or servers. Furthermore, the communication technologies utilized by the communication device may include GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), etc. The input device may be various input means that detect or receive various forms of user input, such as a traditional keypad or keyboard, a mouse, a microphone that receives voice signals, a camera, and others. The output device may be various output means, such as a display that outputs images, a speaker that outputs sound, a haptic device that generates vibrations, and others of various forms.

Furthermore, at least some components within the electronic device 100 may be implemented as an integrated component, or as single or multiple discrete entities. At least some components within the electronic device 100 may be interconnected via a bus, GPIO (general purpose input/output), SPI (serial peripheral interface), or MIPI (mobile industry processor interface), among others, to exchange data and/or signals.

The electronic device 100 of FIG. 1 may perform a method for allocating resources for shooting fire support. Specifically, the electronic device 100 may perform operations to establish a rapid resource allocation plan through a first genetic algorithm for optimizing a first fitness score related to minimizing enemy threat in the battlefield situation and a second genetic algorithm for optimizing a second fitness score related to minimizing firing time, as described in more detail below.

The memory 110 is hardware that stores various data processed within the electronic device 100, and the memory 110 may temporarily or semi-permanently store data processed and data to be processed by the electronic device 100. For example, the memory 110 of the electronic device 100 may store data related to the operating system (OS) for driving the electronic device 100. The memory 110 may include RAM (random access memory) such as DRAM (dynamic random access memory) or SRAM (static random access memory), ROM (read-only memory), EEPROM (electrically erasable programmable read-only memory), CD-ROM, Blu-ray or other optical disk storage, HDD (hard disk drive), SSD (solid state drive), or flash memory. The memory 110 may be provided as an embedded type or a removable type. Furthermore, the memory 110 may store instructions for the operation of the processor 120. Unless otherwise specified, the memory 110 in this disclosure may refer to one or more memories 110 as a set.

The processor 120 is configured to perform operations or data processing related to the control and/or communication of each component of the electronic device 100. For example, the processor 120 may control the electronic device 100 as a whole by executing programs stored in the memory 110 within the electronic device 100. The processor 120 may be implemented as a CPU (central processing unit), GPU (graphics processing unit), AP (application processor), or the like provided within the electronic device 100, but is not limited thereto. Unless otherwise specified, the processor 120 in this disclosure may refer to one or more processors 120 as a set. The processor 120 may be implemented as a computer or similar device based on hardware, software, or a combination thereof. Hardware-wise, the processor 120 may be implemented as an electronic circuit that processes electrical signals to perform control functions. Software-wise, it may be implemented as a program that drives the hardware processor 120. Meanwhile, unless otherwise specified in the following description, the operation of the electronic device 100 may be interpreted as being performed under the control of the processor 120. That is, when modules implemented in the electronic device 100 are executed to perform a method for allocating resources for shooting fire support, the modules may be interpreted as controlling the processor 120 to perform the following operations of the electronic device 100. The method for allocating resources for shooting fire support of the present disclosure performed by the electronic device 100 of FIG. 1 may also be implemented by a non-transitory computer-readable storage medium (or non-transitory recording medium) readable by a computer for its operation. The method may be implemented as a software module or algorithm and may be stored on a computer-readable storage medium as computer-readable code or program instructions executable on a processor 120. Computer-readable storage media include magnetic storage media, such as read-only memory (ROM), random-access memory (RAM), floppy disks, hard disks, etc. and optical recording media, such as CD-ROM, DVD (Digital Versatile Disc), etc. Computer-readable storage media may be distributed across networked computer systems, enabling computer-readable code to be stored and executed in a distributed manner. The media is readable by a computer, stored in memory 110, and executable by a processor 120.

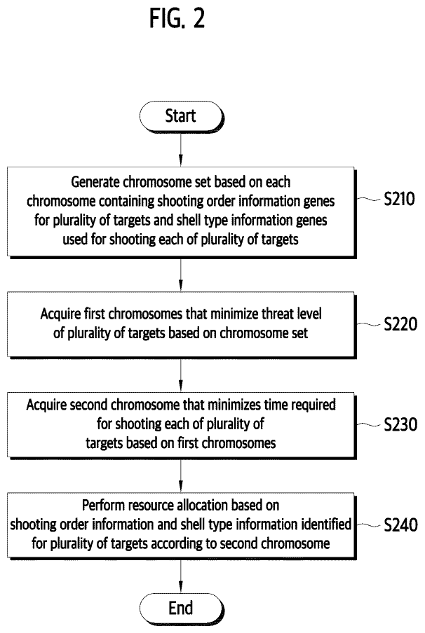

FIG. 2 is a diagram illustrating a method for allocating resources for shooting fire support according to an example embodiment.

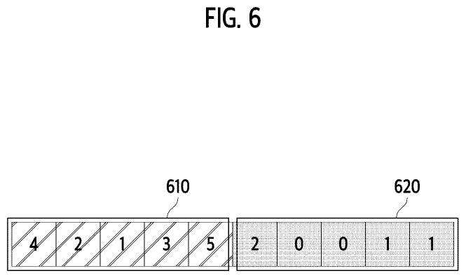

Referring to FIG. 2, the electronic device 100 according to an example embodiment may generate a chromosome set based on each chromosome containing shooting order information genes for a plurality of targets and shell type information genes used for shooting each of the plurality of targets, in operation S210. For example, the shooting order information genes for the plurality of targets may be genes containing information about which target to shoot first among targets having the same shooting priority. The shell type information genes used for shooting each of the plurality of targets may be genes containing information about which type of shell to use to shoot a specific target. The electronic device 100 may generate the chromosome set through an encoding method such that the shooting order information genes for the plurality of targets and the shell type information genes for shooting each of the plurality of targets are included in the correct form and proportion within each chromosome during the process of generating chromosomes randomly or heuristically. The electronic device 100 may perform a genetic algorithm on the generated chromosome set, including initialization, fitness score calculation, selection, crossover, and mutation processes, to acquire chromosomes satisfying specific conditions related to the resource allocation method for shooting fire support. The specific composition of chromosomes according to this disclosure is discussed in more detail in FIG. 6 below.

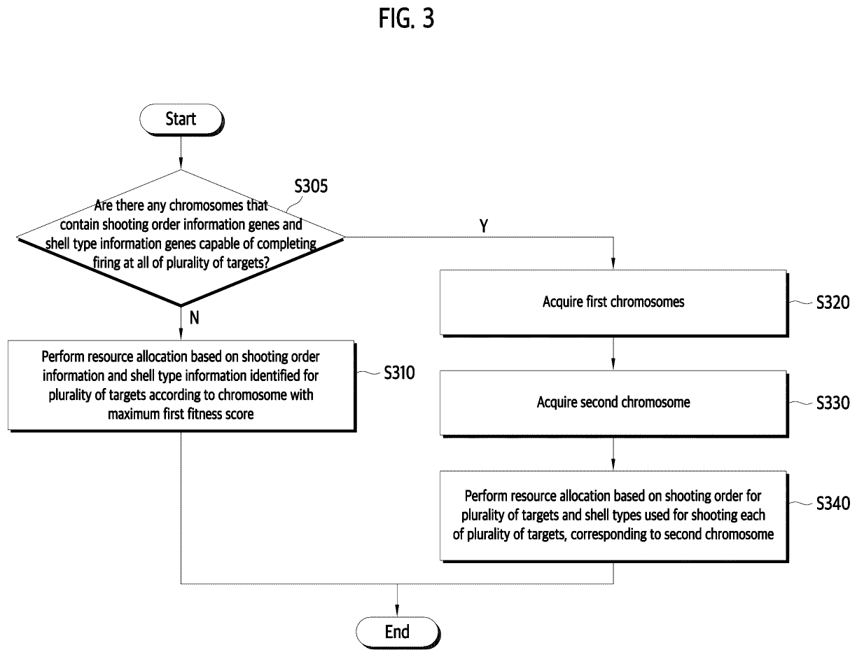

The electronic device 100 according to an example embodiment may acquire first chromosomes that minimize the threat level of the plurality of targets based on the chromosome set, in operation S220. The electronic device 100 may perform a first genetic algorithm based on the chromosome set and perform resource allocation methods for shooting fire support in different ways depending on whether any chromosome containing the shooting order information genes and the shell type information genes capable of completing firing at all of the plurality of targets exist. This case is discussed in more detail in FIG. 3.

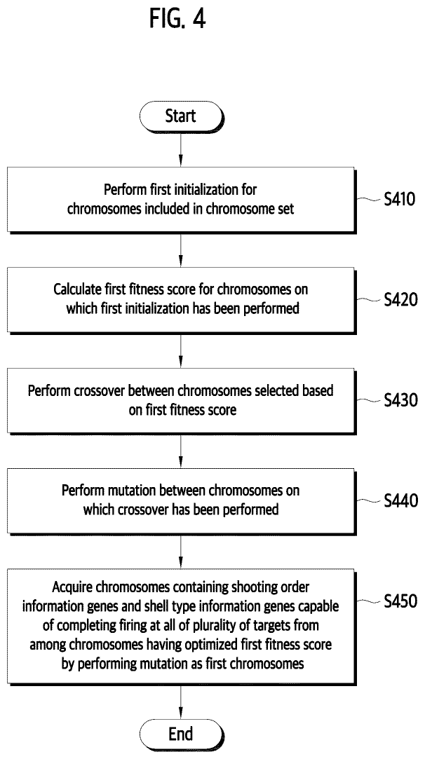

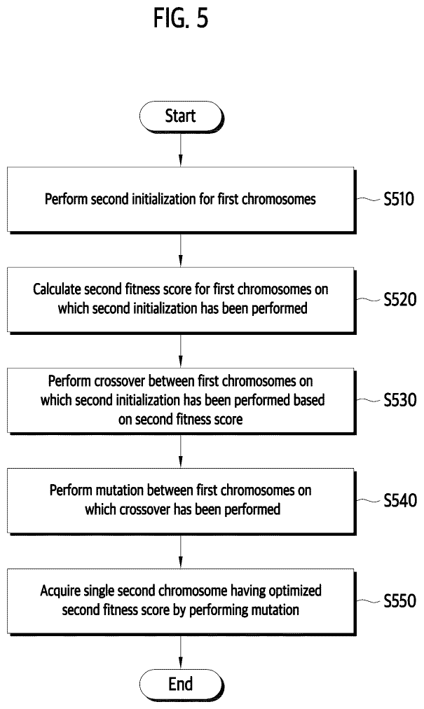

The electronic device 100 according to an example embodiment may acquire a second chromosome that minimizes the time required for shooting each of the plurality of targets based on the first chromosomes, in operation S230. For example, if there is any chromosome containing the shooting order information genes and the shell type information genes capable of firing at all of the plurality of targets exist, in the preceding operation S220, the electronic device 100 may acquire these chromosomes as the first chromosome and then perform a second genetic algorithm to acquire a single second chromosome. The process of performing the second genetic algorithm to acquire the second chromosome and the process of performing the first genetic algorithm may both include initialization, calculation of fitness scores, selection, crossover, and mutation processes, but may differ in their specific methods. These are discussed in more detail below in FIGS. 4 and 5.

The electronic device 100 according to an example embodiment may perform resource allocation in operation S240 based on the shooting order information and the shell type information identified for the plurality of targets according to the second chromosome. The electronic device 100 may acquire the second chromosome through the preceding operations and allocate resources using the shell type corresponding to the shell type information genes used for shooting each of the plurality of targets in the order of shooting order determined according to the shooting order information genes for the plurality of targets and same priority shooting order between targets with the same shooting priority contained in the second chromosome to provide shooting fire support according to the allocated resources.

FIG. 3 is a diagram illustrating a process of performing resource allocation based on resource sufficiency in a method for allocating resources for shooting fire support according to an example embodiment.

Referring to FIG. 3, the electronic device 100 according to an example embodiment may, in operation S305, determine if there are any chromosomes that contain the shooting order information genes and the shell type information genes capable of completing firing at all of the plurality of targets. Based on the results of performing the first genetic algorithm after generating the chromosome set described earlier, the electronic device 100 may determine whether firing completion for all of the plurality of targets is possible upon resource allocation. This determination may be made based on the shooting order information and shell type information identified for the plurality of targets according to the chromosomes having an optimized first fitness score for minimizing enemy threat level.

If the electronic device 100 according to an example embodiment determines in operation S305 that there are no chromosomes containing the shooting order information genes and the shell type information genes that capable of completing firing at all of the plurality of targets, it may perform, in operation S310, resource allocation based on the shooting order information and the shell type information identified for the plurality of targets according to the chromosome with the maximum first fitness score. The electronic device 100 may establish a resource allocation method that minimizes the remaining enemy threat level, even if firing completion for all of the plurality of targets is impossible, when performing resource allocation based on the shooting order information and the shell type information identified for the plurality of targets according to the chromosome with the maximum first fitness score.

If the electronic device 100 according to an example embodiment determines in operation S305 that there are chromosomes containing the shooting order information genes and the shell type information genes that capable of completing firing at all of the plurality of targets, it acquires the first chromosomes in operation S320. Then, it performs a second genetic algorithm on the first chromosomes in operation S330 to acquire a single second chromosome that minimizes the time required for shooting each of the plurality of targets, and performs resource allocation in operation S340 based on the shooting order for the plurality of targets and the shell types used for shooting each of the plurality of targets, corresponding to the second chromosome. Thus, the electronic device 100 may perform resource allocation for shooting fire support in both cases where firing completion for all of the plurality of targets is possible and where it is not possible, based on the result of performing the first genetic algorithm.

FIG. 4 is a diagram illustrating a process of acquiring first chromosomes in a method for allocating resources for shooting fire support according to an example embodiment.

Referring to FIG. 4, the electronic device 100 according to an example embodiment may perform a first initialization for chromosomes included in a chromosome set in operation S410. For example, the chromosome set may include chromosomes containing the shooting order information genes for a plurality of targets and the shell type information genes used for shooting each of the plurality of targets. The electronic device 100 may perform the first initialization by performing random or heuristic-based initialization on the shooting order information genes and the shell type information genes for a plurality of chromosomes included in the chromosome set. For example, the electronic device 100 may perform the first initialization for the chromosome set with a predefined number of chromosomes (e.g., 20) included in the chromosome set.

The electronic device 100 according to an example embodiment may calculate a first fitness score for the chromosomes on which the first initialization has been performed in operation S420. For example, the first fitness score may be determined based on the initial threat levels of the plurality of targets, the residual threat levels of the plurality of the targets after firing according to the resource allocation, the maximum firing time for the plurality of targets, the firing time according to the resource allocation, and a first parameter concerning the time required for shooting fire support. For example, the first fitness score may be defined as shown in Equation 1 below.

$$Fs 1 = ( 1 - α ) \times \frac{initial threat level - residual threat level}{initial threat level} + α \times \frac{maximum firing time - total firing time}{maximum firing time} \qquad [ Equation 1 ]$$

In Equation 1, Fs1 may denote the first fitness score. a may denote the first parameter determining the extent to which the first objective equation considers the total firing time required for shooting fire support, and may have a value between 0 and 1 inclusive. The initial threat level may denote the sum of the threat levels of all enemy targets before firing based on resource allocation commences. The residual threat level may denote the sum of the threat levels of the remaining enemy targets after firing at the plurality of targets according to each chromosome has ended, and may have a value less than or equal to the initial threat level. The maximum firing time may denote an arbitrary maximum firing time (e.g., 1 hour) that may be allocated for firing at the plurality of targets. The total firing time may denote the actual time spent firing based on the resource allocation and may correspond to a time less than or equal to the maximum firing time. The first fitness score may be determined to be larger as the residual threat level is smaller compared to the initial threat level and as the first parameter is smaller.

The electronic device 100 according to an example embodiment may perform a crossover between the chromosomes selected based on the first fitness score in operation S430. For example, for chromosomes on which the first initialization has been performed, the electronic device 100 may select a predetermined number (e.g., 3) of chromosomes in descending order of the first fitness score, and perform the crossover on each of the shooting order information genes for the plurality of targets and the shell type information genes used for shooting each of the plurality of targets contained in the selected chromosomes.

The electronic device 100 may perform the crossover in different ways on each of the shooting order information genes for the plurality of targets and on each of the shell type information genes used for shooting each of the plurality of targets contained in chromosomes. In an example embodiment, the electronic device 100 may perform a partially mapped crossover (PMX) between the shooting order information genes. The electronic device 100 may perform the partially mapped crossover by exchanging the shooting order information genes between two different chromosomes. For example, when a predetermined number of chromosomes are selected, the electronic device 100 may perform the partially mapped crossover between the shooting order information genes of those chromosomes based on a combination that selects two chromosomes from among the predetermined number of chromosomes. The electronic device 100 may determine a first value (e.g., a real number value between 0 and 1 inclusive) during the process of performing the crossover between two different chromosomes, and may determine whether to perform the crossover between the shooting order information genes of the two different chromosomes based on whether the first value is greater than or equal to a first threshold value (e.g., 0.6). For example, if the first value is less than the first threshold value, the electronic device 100 may keep the two different chromosomes unchanged within the chromosome set. For example, if the first value is greater than or equal to the first threshold value, the electronic device 100 may arbitrarily determine two crossover points between the shooting order information genes of each of the two different chromosomes, determine the gene pairs to be exchanged between the shooting order information genes of the two different chromosomes based on the mapping table between the shooting order information genes included between the two arbitrarily determined crossover points, and perform the crossover to generate new chromosomes without duplicating genes with the same shooting order information.

In an example embodiment, the electronic device 100 may perform a two-point crossover between the shell type information genes. For example, when a predetermined number of chromosomes are selected, the electronic device 100 may perform the two-point crossover between the shell type information genes, the shooting order information genes of those chromosomes based on a combination that selects two chromosomes from among the predetermined number of chromosomes. The electronic device 100 may determine a first value (e.g., a real number value between 0 and 1 inclusive) during the process of performing the crossover between two different chromosomes, and may determine whether to perform the crossover between the two different chromosomes based on whether the first value is greater than or equal to a first threshold value (e.g., 0.6). For example, if the first value is less than the first threshold value, the electronic device 100 may keep the two different chromosomes unchanged. For example, if the first value is greater than or equal to the first threshold value, the electronic device 100 may arbitrarily determine two crossover points between the shell type information genes of each of the two different chromosomes and exchange all of the shell type information genes contained between the two arbitrarily determined crossover points to generate new chromosomes.

The electronic device 100 according to an example embodiment may perform a mutation between the chromosomes on which the crossover has been performed in operation S440. Similar to operation S430 discussed earlier, the electronic device 100 may perform the mutation in different ways on each of the shooting order information genes for the plurality of targets and on each of the shell type information genes used for shooting each of the plurality of targets contained in the chromosomes on which the crossover has been performed. In an example embodiment, the electronic device 100 may perform the mutation based on a swap mutation between the shooting order information genes contained in the chromosomes on which the crossover has been performed. The electronic device 100 may perform the mutation by exchanging the positions of the shooting order information genes of the chromosomes based on a combination that selects two chromosomes from among the chromosomes on which the crossover has been performed. The electronic device 100 may determine a second value (e.g., a real number value between 0 and 1 inclusive) during the process of performing the mutation between the shooting order information genes contained in two different chromosomes, and may determine whether to perform the mutation between the shooting order information genes of the chromosomes on which the crossover has been performed based on whether the second value is greater than or equal to a second threshold value (e.g., 0.05). For example, if the second value is less than the second threshold value, the electronic device 100 may not perform the mutation between the shooting order information genes of the chromosomes on which the crossover has been performed and may keep them unchanged within the chromosome set. For example, if the second value is greater than or equal to the second threshold value, the electronic device 100 may randomly determine two genes from among the shooting order information genes of each chromosome on which the crossover has been performed and exchange those two randomly determined genes to generate new chromosomes.

In an example embodiment, the electronic device 100 may perform the mutation based on a random mutation between the shell type information genes contained in the chromosomes on which the crossover has been performed. The electronic device 100 may perform the mutation based on a combination that selects two chromosomes from the chromosomes on which the crossover has been performed by randomly selecting each shell type information gene of those chromosomes from among preset genes. The electronic device 100 may determine a second value (e.g., a real number between 0 and 1 inclusive) during the process of performing the mutation between the shell type information genes contained in two different chromosomes, and may determine whether to perform the mutation between the shell type information genes of the chromosomes on which the crossover has been performed based on whether the second value is greater than or equal to a second threshold value (e.g., 0.05). For example, if the second value is below the second threshold value, the electronic device 100 does not perform the mutation between the shell type information genes of the chromosomes on which the crossover has been performed and may keep them unchanged within the chromosome set. For example, if the second value is greater than or equal to the second threshold value, the electronic device 100 may randomly select and mutate the shell type information genes of each of the chromosomes on which the crossover has been performed from among the preset genes to generate new chromosomes.

The electronic device 100 according to an example embodiment may acquire chromosomes containing the shooting order information genes and the shell type information genes capable of completing firing at all of the plurality of targets from among the chromosomes having an optimized first fitness score by performing the mutation as the first chromosomes, in operation S450. The optimized first fitness score may refer to the highest first fitness score acquirable when operations S410 to S440 are repeated a certain number of times based on new chromosomes generated by performing the mutation acquired in operation S440. The optimized first fitness score may also mean the first fitness score equal to a critical score when the first fitness score does not increase beyond the critical score even after repeating operations S410 to S440 a certain number of times or more based on the new chromosomes generated by performing the mutation acquired in operation S440. The electronic device 100 may perform resource allocation according to the chromosome with the highest optimized first fitness score, as previously discussed, when chromosomes containing the shooting order information genes and the shell type information genes capable of completing firing at all of the plurality of targets do not exist. When one or more chromosomes containing the shooting order information genes and the shell type information genes capable of completing firing at all of the plurality of targets exist, the electronic device 100 may select a specific number of chromosomes from among those chromosomes in descending order of optimized first fitness score to acquire them as first chromosomes and perform a second genetic algorithm based on the first chromosomes.

FIG. 5 is a diagram illustrating a process of acquiring a second chromosome in a method for allocating resources for shooting fire support according to an example embodiment. The process of acquiring the second chromosome, which will be discussed in FIG. 5 below, may include the initialization, calculation of fitness scores, selection, crossover, and mutation processes based on each of the previously acquired first chromosomes, and a process similar to the process of performing the first genetic algorithm described in relation to FIG. 4 may also be performed in the process of performing the second genetic algorithm for acquiring the second chromosome.

Referring to FIG. 5, the electronic device 100 according to an example embodiment may perform a second initialization for the first chromosomes in operation S510. The electronic device 100 may perform the second initialization by generating chromosomes containing random combinations within the shell type information genes used for shooting each of the plurality of targets included in the first chromosome, during the process of performing the second initialization for each of the first chromosomes.

The electronic device 100 according to an example embodiment may calculate a second fitness score for the first chromosomes on which the second initialization has been performed in operation S520. For example, the second fitness score may be determined based on the initial threat levels of the plurality of targets, the residual threat levels of plurality of the targets after firing according to the resource allocation, the maximum firing time for the plurality of targets, the firing time according to the resource allocation, and a second parameter concerning the time required for shooting fire support. For example, the second fitness score may be defined as shown in Equation 2 below.

$$Fs 2 = ( 1 - β ) \times \frac{maximum firing time - total firing time}{maximum firing time} + β \times \frac{initial threat level - residual threat level}{initial threat level} \qquad [ Equation 2 ]$$

Similar to what was discussed in Equation 1 above, Fs2 may denote the second fitness score. β may denote the second parameter determining the extent to which the second objective equation considers the total firing time required for shooting fire support, and may have a value between 0 and 1 inclusive. The initial threat level may denote the sum of the threat levels of all enemy targets before firing based on resource allocation commences. The residual threat level may denote the sum of the threat levels of the remaining enemy targets after firing at the plurality of targets according to each chromosome has ended, and may have a value less than or equal to the initial threat level. The maximum firing time may denote an arbitrary maximum firing time (e.g., 1 hour) that may be allocated for firing at the plurality of targets. The total firing time may denote the actual time spent firing based on the resource allocation and may correspond to a time less than or equal to the maximum firing time. The second fitness score may be determined to be larger as the total firing time is smaller relative to the maximum firing time, and as the second parameter is smaller. Meanwhile, the second parameter used to perform the second genetic algorithm may be set identically to the first parameter used to perform the first genetic algorithm; however, example embodiments according to this disclosure are not limited to the cases where the first parameter and the second parameter are identical. The first parameter and the second parameter may each be set differently as needed in the calculation of the first fitness score and the second fitness score.

The electronic device 100 according to an example embodiment may perform a crossover between the first chromosomes on which the second initialization has been performed based on the second fitness scores in operation S530. For example, for the first chromosomes on which the second initialization has been performed, the electronic device 100 may select a predetermined number (e.g., 3) of chromosomes in descending order of the second fitness score, perform the crossover on the shooting order information genes for the plurality of targets contained in those chromosomes, and may not perform the crossover on the shell type information genes contained in those chromosomes. Similar to how the first value was determined and a partially mapped crossover was performed on the shooting order information genes only when the first value was greater than or equal to the first threshold value during the earlier process of performing the first genetic algorithm, the electronic device 100 may perform the partially mapped crossover only when a randomly determined third value (e.g., a real number value between 0 and 1 inclusive) is greater than or equal to a third threshold value (e.g., 0.6) during the process of performing the crossover on the shooting order information genes for the plurality of targets contained in the first chromosomes on which the second initialization has been performed. The electronic device 100 may not perform the crossover for the shell type information genes contained in the first chromosomes on which the second initialization has been performed. For example, the electronic device 100 may perform the second genetic algorithm such that the shell type information genes used for shooting each of the plurality of targets contained in the second chromosome to be acquired are included in the shell type information genes contained in the first chromosomes.

The electronic device 100 according to an example embodiment may perform a mutation between the first chromosomes on which the crossover has been performed in operation S540. Similar to operation S440 discussed earlier, the electronic device 100 may perform the mutation in different ways on each of the shooting order information genes for the plurality of targets and on each of the shell type information genes used for shooting each of the plurality of targets included in the first chromosomes on which the crossover has been performed. The electronic device 100 may determine a fourth value (e.g., a real number value between 0 and 1 inclusive) and perform the mutation on the shooting order information genes for the plurality of targets based on whether the fourth value is greater than or equal to a fourth threshold value (e.g., 0.05). The electronic device may also perform the mutation on the shell type information genes used for shooting each of the plurality of targets by selecting a random combination within the shell type information genes used for shooting each of the plurality of targets and performing a replacement based on whether the fourth value is greater than or equal to the fourth reference value.

The electronic device 100 according to an example embodiment may acquire a single second chromosome having an optimized second fitness score by performing the mutation in operation S550. The optimized second fitness score may refer to a second fitness score that is equal to a critical score, when the second fitness score does not increase beyond the critical score even after repeating operations S510 to S530 a certain number of times or more based on new chromosomes generated by performing mutation between the first chromosomes on which the crossover has been performed in operation S540. The electronic device 100 may acquire the chromosome with the highest score among the optimized second fitness scores as the second chromosome.

FIG. 6 is a diagram illustrating a chromosome containing shooting order information genes and shell type information genes in a method for allocating resources for shooting fire support according to an example embodiment.

Referring to FIG. 6, a chromosome according to an example embodiment may include shooting order information genes 610 and shell type information genes 620. As previously discussed, the chromosome may refer to the chromosomes included in the chromosome set, the first chromosomes acquired through the first genetic algorithm, and the second chromosome acquired through the second genetic algorithm. Meanwhile, the case shown in FIG. 6 is merely illustrative, and the number of the plurality of targets, the shooting order information genes, and the shell type information genes according to this disclosure are not limited to any particular case.

The shooting order information genes 610 for the plurality of targets contained in the chromosome according to an example embodiment may be genes containing information about which target to shoot first among targets having the same shooting priority. For example, the shooting priority may correspond to a predetermined shooting priority established through instructions from higher authorities, and the shooting order information for the plurality of targets may be used to determine the shooting order among the plurality of targets having the same shooting priority. The shooting order information genes 610 for the plurality of targets included in the chromosome according to an example embodiment may contain information corresponding to one of the permutations corresponding to the factorial of the number of the plurality of targets. For example, as shown in FIG. 6, when the number of enemy targets is 5, if all enemy targets have the same shooting priority, the shooting order information between the plurality of targets with the same shooting priority may be based on any one of 120 permutations corresponding to the number of permutations listing 1 through 5, which is 5!.

The shell type information genes 620 used for shooting each of the plurality of targets contained in the chromosome according to an example embodiment may include shell type information used for shooting targets corresponding to respective genes contained in the shooting order information genes 610. For example, the shell type may include different types of shells such as a first shell, a second shell, and a third shell (e.g., an ICM, a DPICM, and an HE).

The number of genes included in the shooting order information genes 610 for the plurality of targets contained in the chromosome according to an example embodiment may be equal to the number of the plurality of targets to be shot. The number of genes included in the shell type information genes 620 used for shooting each of the plurality of targets may also be equal to the number of the plurality of targets to be shot. The number of genes of the chromosome may be determined based on the sum of the number of genes included in the shooting order information genes 610 for the plurality of targets and the number of genes included in the shell type information genes 620 used for shooting each of the plurality of targets. For example, the number of genes contained in the chromosome may correspond to twice the number of the plurality of targets. In other words, based on FIG. 6, if the number of the plurality of targets to be shot is 5, the number of genes included in the shooting order information genes 610 and the number of genes included in the shell type information genes 620 used for shooting each of the plurality of targets may both be 5, respectively, and the number of genes contained in the chromosome may be 10.

The resource allocation method for shooting fire support is discussed in more detail based on the shooting order information genes 610 and shell type information genes 620 for the plurality of targets in FIG. 6. It can be seen that enemy target 1 is assigned the 4th order in the same priority shooting order, enemy target 2 is assigned the 2nd order, enemy target 3 is assigned the 1st order, enemy target 4 is assigned the 3rd order, and enemy target 5 is assigned the 5th order. For example, if the predefined shooting priority is (1, 2, 2, 3, 4), enemy target 2 and enemy target 3 have the same shooting priority of 2. Thus, the resource allocation based on the predefined shooting priority, same priority shooting order information contained in the shooting order information genes 610, and the shell type information genes 620 may be determined to perform shooting fire support in the following order: enemy target 1 (shoot with DPICM corresponding to gene 2)→enemy target 3 (shoot with HE corresponding to gene 0)→enemy target 2 (shoot with HE corresponding to gene 0)→enemy target 4 (shoot with ICM corresponding to gene 1)→enemy target 5 (shoot with ICM corresponding to gene 1).

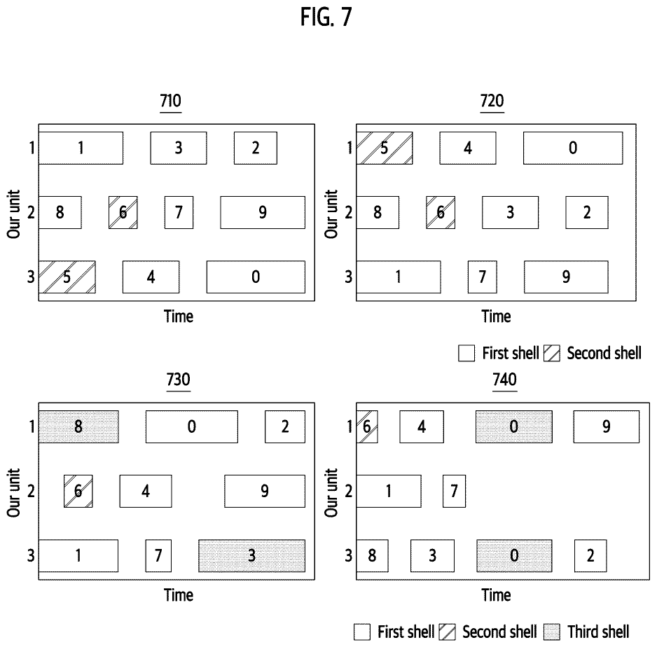

FIG. 7 is an example diagram illustrating an example of performing shooting fire support according to a method for allocating resources for shooting fire support according to an example embodiment.

Referring to FIG. 7, simulation results concerning shooting fire support based on the resource allocation method performed by the electronic device 100 according to an example embodiment are shown. For example, the simulation may be performed based on a mathematical model satisfying conditions set to minimize the enemy threat, and additionally, it may be performed based on chromosomes acquired through the multiple genetic algorithm processes previously discussed. For example, the set conditions for the mathematical model may include the constraints described in Table 1 below.

TABLE 1
Constraints
$max {\sum }_{i ∈ l} {\sum }_{j ∈ J} {Threat}_{j} {y}_{ij} - α \cdot z$
$s . t . {\sum }_{i ∈ I} {\sum }_{k ∈ K} {\sum }_{t ∈ T} {x}_{ij}^{k𝔱} = {d}_{j} , ∀ j ∈ J$
${F}_{ij} \geq {tx}_{ij}^{kt} , ∀ i ∈ I , j ∈ J , k ∈ K , t ∈ T$
${F}_{ij} \leq {tx}_{ij}^{kt} + ( 1 - {bf}_{ij}^{kt} ) M , ∀ i ∈ I , j ∈ J , k ∈ K , t ∈ T$
${\sum }_{i ∈ I} {\sum }_{k ∈ K} {\sum }_{t ∈ T} {bf}_{ij}^{kt} = 1 , ∀ j ∈ J$
${S}_{ij} \leq {tx}_{ij}^{kt} + ( 1 - {x}_{ij}^{kt} ) M , ∀ i ∈ I , j ∈ J , k ∈ K , t ∈ T$
${s}_{ij} \geq {tx}_{ij}^{kt} + ( 1 - {bs}_{ij}^{kt} ) M , ∀ i ∈ I , j ∈ J , k ∈ K , t ∈ T$
${\sum }_{i ∈ I} {\sum }_{k ∈ K} {\sum }_{t ∈ T} {bs}_{ij}^{k τ} = 1 , ∀ j ∈ J$
sᵢⱼ = Fᵢⱼ − dⱼ + 1, ∀j ∈ J
sᵢⱼ = s_{ij′}, ∀i ∈ I, j ∈ J, k ∈ K, j′ ∈ Divⱼ
${\sum }_{i ∈ I} {\sum }_{t ∈ T} {r}_{ij}^{k} {x}_{ij}^{kt} = {demand}_{j}^{k} , ∀ j ∈ J , k ∈ K$
${\sum }_{j ∈ J} {\sum }_{𝔱 ∈ T} {r}_{j}^{k} {x}_{ij}^{kt} \leq {R}_{i}^{k} , ∀ i ∈ I , k ∈ K$
${\sum }_{i ∈ I} {\sum }_{j ∈ J} {\sum }_{t ∈ T} {r}_{j}^{k} {x}_{ij}^{kt} \leq {R}_{max}^{k} , k ∈ K$
Fᵢⱼ + 1 ≤ Sᵢₚ, ∀i ∈ I, j ∈ J, p ∈ PSⱼ
z ≥ Fᵢⱼ + 1, ∀i ∈ I, j ∈ J
z ≤ Fₘₐₓ
${\sum }_{j ∈ J ∖ {Dis𝔱}_{j}^{k}} {\sum }_{t ∈ T} {x}_{ij}^{kt} = 0 , ∀ i ∈ I , k ∈ K$
${\sum }_{t ∈ T} {x}_{ij}^{kt} + {bf}_{ij}^{kt} + {bs}_{ij}^{kt} \leq {My}_{ij} , ∀ i ∈ I , j ∈ J , k ∈ K$
Σ_{i∈I} yᵢⱼ ≤ 1, ∀j ∈
${x}_{ij}^{kt} ∈ \{ 0 , 1 \} , ∀ i ∈ I , j ∈ J , k ∈ K , t ∈ T$
yᵢⱼ ∈ {0,1}, ∀i ∈ I, j ∈ J
${bf}_{ij}^{kt} ∈ \{ 0 , 1 \} , ∀ i ∈ I , j ∈ J , k ∈ K , t ∈ T$
${bs}_{ij}^{kt} ∈ \{ 0 , 1 \} , ∀ i ∈ I , j ∈ J , k ∈ K , t ∈ T$
Fᵢⱼ ∈ [symbol] ⁺, ∀i ∈ I, j ∈ J, k ∈ K, t ∈ T
sᵢⱼ ∈ [symbol] ⁺, ∀i ∈ I, j ∈ k ∈ K, t ∈T
z ∈ [symbol] ⁺, ∀j ∈ J, k ∈ K, t ∈ T

The variables representing each set, the variables representing parameters, and the decision variables in the constraints shown in Table 1 can be defined as in Table 2.

TABLE 2

| | |
|---|---|
| Variables representing sets | I: set of batteries i |
| | J: set of targets j |
| | K: set of shells k |
| | T: set of times t |
| | PSⱼ: set of following targets of targets j |
| | Divⱼ: set of targets on which preprocessing has been |
| | $performed for target j if {demand}_{j}^{k} > 10 ( {Div}_{j} ⊂ J )$ |
| | ${Dist}_{j}^{k} : set of targets j within firing range when$ |
| | $battery i uses shell k ( {Dist}_{j}^{k} ⊂ J )$ |
| Variables representing parameters | ${R}_{i}^{k} : number of available shells k for battery i$ |
| | ${R}_{max}^{k} : number of available shells k$ |
| | ${r}_{j}^{k} : number of shells k required for shooting target j$ |
| | ${d}_{j}^{k} : time to shoot target j when using shell k$ |
| | ${demand}_{j}^{k} : number of shells k required to shoot target j$ |
| | Threatⱼ: threat level of target j |
| | Fₘₐₓ: total firing time limit |
| | α: parameters determining the extent to which the total |
| | firing time is taken into account in the first and second |
| | fitness scores (0 ≤ α ≤1) |
| | M: sufficiently large number |
| Decision variables | ${x}_{ij}^{kt} : binary variable that is 1 if battery i shoots target$ |
| | j with shell k at time point t, and 0 otherwise |
| | yᵢⱼ: binary variable that is 1 if battery i shoots target |
| | j, and 0 otherwise |
| | Sᵢⱼ: integer variable indicating start time of shooting |
| | target j by battery i |
| | Fᵢⱼ: integer variable indicating end time of shooting |
| | target j by battery i |
| | z: integer variable having a value equal to (maximum |
| | value + 1) of Fᵢ |
| | ${bs}_{ij}^{kt} : binary variable allowing to calculate the value of$ |
| | ${S}_{i} based on the value of {x}_{ij}^{kt}$ |
| | ${bf}_{ij}^{kt} : binary variable allowing to calculate the value$ |
| | $of {F}_{i} based on the value of {x}_{ij}^{kt}$ |

The mathematical model environment in which the simulation of shooting fire support according to the resource allocation method performed by the electronic device 100 according to the constraints and variables of Tables 1 and 2 is performed and the situation where in which the resource allocation is performed based on the chromosomes acquired through multiple genetic algorithm processes may further include the conditions in Table 3 below.

TABLE 3
(1) The basic unit of the weapon system is defined as a battery (6 guns).
(2) Information regarding the target's threat level and location,
desired effect (suppression, neutralization, destruction), shooting
priority, required number of rounds per target-shell type for
each desired effect, and total firing time is provided in advance.
(3) The effective firing range of the battery and the allocated
resources per shell type are provided in advance.
(4) The transition time between completing firing at one target
and commencing firing at another is 1 minute.
(5) The firing rate applies a sustained rate of fire, firing
2 rounds per minute.
(6) A single battery fires at only one target at a time, with
each gun using the same type of shell.
(7) Once firing commences, it does not cease until the firing is complete.
(8) Multiple batteries may simultaneously fire at the same target.
In this case, the minimum number of batteries fire simultaneously
to ensure no single unit fires more than 10 rounds at one target.
The firing start time is identical for all batteries.
(9) Batteries do not relocate except for position changes,
performing short-range position changes that do not alter
the battery's available targets.
(10) Threat reduction varies depending on the desired effect
(suppression: 10%, neutralization: 20%, destruction: 30%) and
is calculated using linear interpolation based on ammunition consumption.

The electronic device 100 may generate Div; set for preprocessing to limit the firing of more than 10 rounds per battery in relation to condition (6) of Table 3 above in the mathematical model for simulation, adjusting to ensure firing is evenly distributed across the minimum number of batteries while keeping

$${demand}_{j}^{k}$$

below 10 (For example, set to

$${demand}_{j}^{a} = 6 , {demand}_{j 1}^{a} = 6 ,$$

if firing 12 rounds at target j with shell a is required). The electronic device 100 may perform simulations based on constraints similar to real battlefield situations by reflecting the transition time required to change the target and fire by adding it to the target's firing time.

A simulation result 710 and a simulation result 720 show cases where a resource allocation method allowing firing at all of the plurality of targets exists. The simulation result 710 shows a simulation outcome based on the mathematical model. This is a case where the enemy threat is minimized by allocating resources in the following manner: for enemy targets (enemy target 0 to enemy target 9), our unit 1 fires at enemy target 1, enemy target 3, and enemy target 2 in that order using the first shell, our unit 2 fires at enemy target 8 using the first shell, then fires at enemy target 6 using the second shell, and fires at enemy target 7 and enemy target 9 using the first shell, and our unit 3 fires at enemy target 5 using the second shell.

The simulation result 720 shows a simulation outcome based on the results of performing the genetic algorithm according to the present disclosure. For the same enemy targets, the enemy threat level may be minimized by allocating resources in the following manner: our unit 1 fires at enemy target 5 using the second shell, then fires at enemy target 4 and enemy target 9 in sequence using the first shell, our unit 2 fires at enemy target 8 using the first shell, then fires at enemy target 6 using the second shell, and fires at enemy target 3 and enemy target 2 using the first shell, and our unit 3 fires at enemy target 1, enemy target 7, and enemy target 9 in that order using the first shell.

A simulation result 730 and a simulation result 740 show cases where no resource allocation method allowing firing at all of the plurality of targets exists. The simulation result 730 shows a simulation outcome based on the mathematical model. This is a case where the enemy threat is minimized by allocating resources in the following manner: for enemy targets (enemy target 0 to enemy target 9), our unit 1 fires at enemy target 8 using the third shell, then fires at enemy target 0 and enemy target 2 in that order using the first shell, our unit 2 fires at enemy target 6 using the second shell, then fires at enemy target 4 and enemy target 9 using the first shell, and our unit 3 fires at enemy target 1 and enemy target 7 using the first shell, then fires at enemy target 3 using the third shell. It can be seen that, unlike previous simulations where firing at all of the plurality of targets was possible using only the first shell and the second shell, it is impossible to fire at enemy target 5 even using all of the first shell to the third shell in the simulation result 730.

The simulation result 740 shows a simulation outcome based on the results of performing the genetic algorithm according to the present disclosure, and it can be seen that our unit 1 fires at enemy target 6 using the second shell, then fires at enemy target 4 using the first shell, fires at enemy target 0 using the third shell, and fires at enemy target 9 again using the first shell. Additionally, our unit 2 fires at enemy target 1 followed by enemy target 7 using the first shell, while our unit 3 fires at enemy target 8 and enemy target 3 using the first shell, then fires at enemy target 0 using the third shell, and again fires at enemy target 2 using the first shell. This demonstrates resource allocation that minimizes enemy threat levels. The specific resource allocation method observable in the simulation result 740 differs from that in the simulation result 730, but similarly confirms that even using all of the first shell to the third shell, firing at enemy target 5 remains impossible. The electronic device 100 may establish a resource allocation method for providing shooting fire support in the battlefield situation based on the constraints and whether firing may be completed for all of the plurality of targets as discussed throughout the explanation related to FIG. 7.

According to example embodiments, it is possible to assist in making optimized decisions in rapidly changing battlefield situations requiring swift and accurate decisions, by comprehensively considering various variables and constraints for implementing real battlefield conditions, as well as whether all enemy targets may be engaged, through a method for allocating resources for shooting fire support applicable to a decision support system that assists unit commanders in rapid decision-making by an electronic device.

The effects of the present disclosure are not limited to the effects mentioned above, and other effects not mentioned will be clearly understood by those skilled in the art from the description of the claims.

The electronic device according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-access memory), floppy disk, hard disk, etc.) and optical reading medium (e.g., CD-ROM and DVD (Digital Versatile Disc)). The computer-readable recording medium is distributed over networked computer systems, so that computer-readable codes may be stored and executed in a distributed manner. The medium is readable by a computer, stored in a memory, and executed on a processor.

The present example embodiment may be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components may be implemented with software programming or software elements, this example embodiment includes various algorithms implemented with a combination of data structures, processes, routines or other programming components and may be implemented with a programming or scripting language including C, C++, Java, assembler, etc. Functional aspects may be implemented with an algorithm running on one or more processors. In addition, the present example embodiment may employ a conventional technique for at least one of electronic environment setting, signal processing, and data processing. Terms such as “mechanism”, “element”, “means”, and “composition” may be used in a broad sense, and are not limited to mechanical and physical configurations. Those terms may include the meaning of a series of routines of software in connection with a processor or the like.

It will be apparent to those skilled in the art that various modifications and variations can be made in the foregoing embodiments without departing from the spirit or scope of the invention. Thus, it is intended that the present invention cover the modifications and variations of this invention provided they come within the scope of the appended claims and their equivalents.

What is claimed is:

1. A method for allocating resources for shooting fire support, the method comprising:
generating a chromosome set based on each chromosome containing shooting order information genes for a plurality of targets and shell type information genes used for shooting each of the plurality of targets;
acquiring first chromosomes that minimize a threat level of the plurality of targets based on the chromosome set;
acquiring a second chromosome that minimizes a time required for shooting each of the plurality of targets based on the first chromosomes; and
performing resource allocation based on shooting order information and shell type information identified for the plurality of targets according to the second chromosome.

2. The method of claim 1, wherein the acquiring of the first chromosomes comprises:
performing a first initialization on chromosomes included in the chromosome set;
calculating a first fitness score for chromosomes on which the first initialization has been performed;
performing a crossover between chromosomes selected based on the first fitness score;
performing a mutation between chromosomes on which the crossover has been performed; and
acquiring chromosomes as the first chromosomes, which contain the shooting order information genes and the shell type information genes capable of completing firing at all of the plurality of targets, from among chromosomes having the first fitness score optimized by performing the mutation.

3. The method of claim 2, wherein the performing of the crossover comprises:
performing a partially mapped crossover between the shooting order information genes contained in the chromosomes selected based on the first fitness score; and
performing a two-point crossover between the shell type information genes contained in the chromosomes selected based on the first fitness score.

4. The method of claim 2, wherein the performing of the mutation comprises:
changing an order of the shooting order information genes contained in the chromosomes on which the crossover has been performed; and
randomly selecting and determining each of the shell type information genes contained in the chromosomes on which the crossover has been performed from among preset genes.

5. The method of claim 2, wherein the first fitness score is determined based on an initial threat level of the plurality of targets, a residual threat level of the plurality of targets after firing according to the resource allocation, a maximum firing time for the plurality of targets, a firing time according to the resource allocation, and a first parameter concerning a time required for shooting fire support.

6. The method of claim 1, wherein the acquiring of the second chromosome comprises:
performing a second initialization on the first chromosomes;
calculating a second fitness score for the first chromosomes on which the second initialization has been performed;
performing a crossover between the first chromosomes on which the second initialization has been performed, based on the second fitness score; and
acquiring one chromosome as the second chromosomes, which has the second fitness score optimized by performing the mutation between the first chromosomes on which the crossover has been performed.

7. The method of claim 6, wherein the second fitness score is determined based on an initial threat level of the plurality of targets, a residual threat level of the plurality of targets after firing according to the resource allocation, a maximum firing time for the plurality of targets, a firing time according to the resource allocation, and a second parameter concerning a time required for shooting fire support.

8. The method of claim 6, wherein the shell type information genes contained in the second chromosome are included in the shell type information genes contained in the first chromosomes.

9. The method of claim 2, further comprising:
when chromosomes containing the shooting order information genes and the shell type information genes capable of completing firing at all of the plurality of targets do not exist, performing the resource allocation based on the shooting order information and shell type information identified for the plurality of targets according to the chromosome with the maximum first fitness score.

10. A non-transitory computer-readable storage medium having a program for executing a method for allocating resources for shooting fire support on a computer recorded thereon, the method comprising:
generating a chromosome set based on each chromosome containing shooting order information genes for a plurality of targets and shell type information genes used for shooting each of the plurality of targets;
acquiring first chromosomes that minimize a threat level of the plurality of targets based on the chromosome set;
acquiring a second chromosome that minimizes a time required for shooting each of the plurality of targets based on the first chromosomes; and
performing resource allocation based on shooting order information and shell type information identified for the plurality of targets according to the second chromosome.

11. An electronic device for performing a method for allocating resources for shooting fire support, the electronic device comprising:
a memory; and
a processor, wherein the processor is configured to:
generate a chromosome set based on each chromosome containing shooting order information genes for a plurality of targets and shell type information genes used for shooting each of the plurality of targets;
acquire first chromosomes that minimize a threat level of the plurality of targets based on the chromosome set;
acquire a second chromosome that minimizes a time required for shooting each of the plurality of targets based on the first chromosomes; and
perform resource allocation based on shooting order information and shell type information identified for the plurality of targets according to the second chromosome.
